(19) United States
(12) Patent Application Publication
(10) Pub. No.: US 2026/0212121 A1
(43) Pub. Date: Jul. 23, 2026

(54) SYSTEM AND METHOD FOR CONTROLLED CONTENT GENERATION USING DYNAMIC FRAGMENT CONSTRAINTS

(71) Applicant: Emcie Co Ltd., Herzlia (IL)

(72) Inventors: Dor ZOHAR, Givataim (IL); Yam MARCOVITZ, Herzliya (IL); Bar KAROV, Tel-Aviv (IL)

(73) Assignee: Emcie Co Ltd., Herzlia (IL)

(21) Appl. No.: 19/455,949

(22) Filed: Jan. 22, 2026

Related U.S. Application Data
(60) Provisional application No. 63/747,932, filed on Jan. 22, 2025.

(51) Int. Cl. G06F 40/284; G06F 40/30; G06N 3/0475

(52) U.S. Cl. CPC G06F 40/284; G06F 40/30; G06N 3/0475

(57) ABSTRACT

There is provided a computer implemented method of controlling a response by a generative model, comprising: using at least one processor for: receiving an input message, maintaining a fragment repository comprising a plurality of predefined text fragments, wherein each text fragment includes at least a complete word, iteratively selecting, by the generative model, a set of text fragments from the fragment repository based on the input message, assembling, by the generative model, the set of selected text fragments into a composite response, and providing the composite response for presentation within a user interface on a display of a client terminal.

### RELATED APPLICATION(S)

This application claims the benefit of priority of U.S. Provisional Patent Application No. 63/747,932 filed on Jan. 22, 2025, the contents of which are all incorporated by reference in as if fully set forth herein their entirety.

### BACKGROUND

The present invention, in some embodiments thereof, relates to generative models and, more specifically, but not exclusively, to a system and method for controlled content generation using dynamic fragment constraints.

Generative AI technologies, particularly Large Language Models (LLMs), are increasingly being deployed for customer interactions through chatbots, voice assistants, and other digital channels.

### SUMMARY

According to a first aspect, a computer implemented method of controlling a response by a generative model, comprises: using at least one processor for: receiving an input message, maintaining a fragment repository comprising a plurality of predefined text fragments, wherein each text fragment includes at least a complete word, iteratively selecting, by the generative model, a set of text fragments from the fragment repository based on the input message, assembling, by the generative model, the set of selected text fragments into a composite response, and providing the composite response for presentation within a user interface on a display of a client terminal.

According to a second aspect, a system for controlling a response by a generative model, comprises: at least one processor executing a code for: receiving an input message, maintaining a fragment repository comprising a plurality of predefined text fragments, wherein each text fragment includes at least a complete word, iteratively selecting, by the generative model, a set of text fragments from the fragment repository based on the input message, assembling, by the generative model, the set of selected text fragments into a composite response, and providing the composite response for presentation within a user interface on a display of a client terminal.

According to a third aspect, a non-transitory medium storing program instructions for controlling a response by a generative model, which when executed by at least one processor, cause the at least one processor to: receive an input message, maintain a fragment repository comprising a plurality of predefined text fragments, wherein each text fragment includes at least a complete word, iteratively select, by the generative model, a set of text fragments from the fragment repository based on the input message, assemble, by the generative model, the set of selected text fragments into a composite response, and provide the composite response for presentation within a user interface on a display of a client terminal.

In a further implementation form of the first, second, and third aspects, the composite response has significantly reduced unintended and/or non-compliant responses in comparison to a second composite response generated by a second generative model configured to generate a complete response without accessing the fragment repository.

In a further implementation form of the first, second, and third aspects, the composite response has at least about 70% reduction in unintended and/or non-compliant responses in comparison to a second composite response generated by a second generative model configured to generate a complete response without accessing the fragment repository.

In a further implementation form of the first, second, and third aspects, each text fragment included in the set is exclusively selected from the fragment repository.

In a further implementation form of the first, second, and third aspects, the iteratively selecting the set is implemented until a termination condition is met, the termination condition includes at least one of: selection of a stop fragment, reaching a predefined maximum number of text fragments in the set, and reaching a predefined total maximum length of the text fragments in the set.

In a further implementation form of the first, second, and third aspects, the input message includes at least one of: a user message or conversation history.

In a further implementation form of the first, second, and third aspects, the generative model is implemented as natural language processing (NLP) model.

In a further implementation form of the first, second, and third aspects, the NLP model is implemented as a large language model (LLM) or a classifier.

In a further implementation form of the first, second, and third aspects, significantly reducing unintended and/or non-compliant responses comprises significantly reducing at least one of: hallucinations, incorrect content, unverifiable content, incoherent content, unintended content, and untimely content.

In a further implementation form of the first, second, and third aspects, the fragment repository includes at least one of: individual words, phrases, complete sentences, partial paragraphs, complete paragraphs, partial text item including a first set of a plurality of paragraphs, complete text item including a second set of a plurality of paragraphs.

In a further implementation form of the first, second, and third aspects, the generative model includes a trained fragment predictor configured to select fragments exclusively from the fragment repository in view of the input message.

In a further implementation form of the first, second, and third aspects, the generative model is trained on a training dataset that includes text external to the fragment repository, wherein the generative model is in communication with a generation engine configured to perform the iterative selection of the set of fragments, wherein the input message comprises a first input message, and further comprising generating a second input message from the first input message, the second input message instructing the generative model to generate the composite response by implementing the assembling as a response to the first input message without including additional text external to the fragment repository.

In a further implementation form of the first, second, and third aspects, the fragment repository includes at least one of: new line marker, at least one punctuation mark, and at least one formatting element.

In a further implementation form of the first, second, and third aspects, further comprising providing a second user interface for presentation on a display configured for personalizing the fragments included in the fragment repository.

In a further implementation form of the first, second, and third aspects, the fragment repository excludes text fragments smaller than the complete word.

In a further implementation form of the first, second, and third aspects, at least one fragment of the plurality of predefined text fragments stored by the fragment repository further includes parameterized variable placeholders, and further comprising: dynamically resolving parameterized variable placeholders in the set of text fragments from contextual data sources.

In a further implementation form of the first, second, and third aspects, further comprising: in response to a failure of dynamically resolving at least one parameterized variable placeholder of at least one candidate text fragment using the contextual data sources, excluding the at least one candidate text fragment from being selected for including in the set of text fragments which are assembled into the composite response.

In a further implementation form of the first, second, and third aspects, at least one fragment in the fragment repository is stored in association with contextual cues, and further comprising: obtaining active contextual cues associated with the input message, dynamically filtering the plurality of predefined text fragments of the fragment repository based on active contextual cues to generate a filtered set, wherein the iteratively selecting is performed from the filtered set.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for operating a generative model(s) that generates content excluding hallucinations, in accordance with some embodiments of the present invention;

FIG. 2 is a flowchart of a method of operating a generative model(s) that generates content excluding hallucinations, in accordance with some embodiments of the present invention;

FIG. 3 is a dataflow diagram depicting an exemplary dataflow for dynamic selection of fragments for generation of a composite response in response to an input message, in accordance with some embodiments of the present invention;

FIG. 4 is a sequence diagram for operating a generative model(s) that generates content excluding hallucinations, in accordance with some embodiments of the present invention;

FIG. 5 is a flowchart of an exemplary process for filtering fragments of the fragment repository based on contextual cues, in accordance with some embodiments of the present invention; and

FIG. 6 is a flowchart of an exemplary dataflow for dynamic selection of fragments for generation of a composite response in response to an input message, in accordance with some embodiments of the present invention.

### DETAILED DESCRIPTION

The present invention, in some embodiments thereof, relates to generative models and, more specifically, but not exclusively, to a system and method for controlled content generation using dynamic fragment constraints.

As used herein, the term “hallucination” refers to incorrect content, unverifiable content, unintended content, untimely content, and/or incoherent content generated by a generative model. As used herein the terms “hallucination” and “unintended and/or non-compliant response” are used interchangeably.

As used herein, the term “excluding” and “significantly reducing the likelihood of” may be used interchangeably. It is noted that excluding is not necessarily absolute (i.e., not necessarily 100% accurate). Since the generative model is statistical based, it may not be possible to obtain 100% exclusion while maintaining performance of the generative model. Excluding and/or significantly reducing the likelihood of unintended and/or non-compliant responses (i.e., hallucinations) may refer to a reduction of about, for example, at least 70%, or 80%, or 90%, or 95%, or 99%, or other values. The reduction may be for the generative model based on at least one embodiment described herein in comparison to the generative model without implementing at least one embodiment described herein.

An aspect of some embodiments of the present invention relates to systems, methods, computing devices, and/or code instructions (e.g., stored on a data storage device and executable by one or more processors) for controlling a response generated by a generative model in response to an input message. The generative model may be designed and/or operated to generate the response with significantly reduced likelihood of or elimination of hallucinations. The input message (e.g., natural language text input message) may be provided, for example, entered by a user via a user interface presented on a display of a client terminal, such as designed for a chat session between the user and the generative model. A fragment repository of predefined text fragments is maintained. Each text fragment includes at least a complete word. Examples of additional fragments include individual words, phrases, complete sentences, partial paragraphs, complete paragraphs, partial text item including one or more paragraphs, and a complete text item including one or more paragraphs. A set of text fragments is iteratively selected from the fragment repository based on the text input message. The text fragments may be sequentially selected, for example, by a predictor model based on a history of previously selected text fragments and in view of the input message. The predictor model may be integrated within the generative model, and/or may be implemented as an external component in communication with the generative model (e.g., via an application programming interface (API), software development kit (SDK), and the like). The set of selected text fragments are dynamically assembled (e.g., by the generative model and/or another model) into a composite response. The composite response is provided, for example, for presentation within the user interface on the display of the client terminal. Generating the composite response by exclusively assembling the selected set of text fragments, significantly reduces or eliminates the risk of hallucinations in the composite response. Risk of hallucinations may be significantly reduced or eliminated by selective curating of the fragment repository. For example, the fragment repository may be generated for a specific domain, such as customer service for an airline. The fragments in the fragment repository may be selected to cover possible fragments of answers to provide for customers inquiring about different services and/or problems with the airline, while excluding fragments unrelated to other topics. This prevents or significantly reduces the risk of the generative model providing irrelevant results.

At least one embodiment described herein addresses the technical problem of a generative model generating “hallucinations”. At least one embodiment described herein improves the technology of generative models, by preventing a generative model from generating hallucinations. At least one embodiment described herein provides the practical application of providing a generative model that generates content without hallucinations.

Generative AI technologies, particularly Large Language Models (LLMs), are increasingly being deployed for user interactions through, for example, text-based chatbots, voice assistants, interactive voice response (IVR) systems, and/or other digital channels. These systems generate natural language text that may be displayed directly to users or synthesized into voice-audio for spoken delivery. However, entities (e.g., organizations) in regulated industries face significant challenges in ensuring these AI systems consistently produce compliant outputs regardless of output modality.

The fundamental challenge stems from how LLMs generate responses. These generative models process language by breaking it into “tokens” (e.g., word fragments) and generate responses based on patterns learned from diverse and often inconsistent training data. Because tokens are small units and extremely diverse, and that the generative models are statistical based, the generative outputs of these generative models may include hallucinations. This problem affects both text and voice-audio outputs, as voice systems typically rely on text generation followed by speech synthesis. For entities (e.g., organizations) operating under strict regulatory requirements, these unpredictable outputs present an unacceptable risk. As a result, many entities in regulated sectors have been unable to leverage generative AI (e.g., for customer service applications) despite the technology's clear potential for improving operational efficiency and/or user (e.g., customer) experience.

At least one embodiment potentially dramatically reduces—or potentially eliminates—undesirable outputs in applications such as customer service interactions, provided the fragment selection is appropriately curated. This makes at least one embodiment particularly valuable for scenarios requiring strict content control and compliance.

At least one embodiment provides control over Natural Language Processing (NLP) (i.e., generative) models responses while significantly reducing the likelihood of unintended and/or non-compliant responses.

At least one embodiment provides operators with greater precision and/or reliability in AI-generated content, addressing the technical problem described herein in the deployment of generative AI systems.

At least one embodiment solves the aforementioned technical problem, and/or improves upon the aforementioned technical field, and/or provides the aforementioned practical approach, by for controlling a response generated by a generative model in response to an input message such that the response has significantly reduced likelihood of or eliminates hallucinations. The input message is provided. A fragment repository of predefined text fragments is maintained. Each text fragment includes at least a complete word. A set of text fragments is iteratively selected from the fragment repository based on the text input message. The set of selected text fragments are dynamically assembled into a composite response. The composite response is provided.

It is noted that the inclusion of text fragments which are at least a complete word, and assembling those text fragments into the composite response is different than the processing approaches of standard natural language processing models (such as large language models (LLMs) which use fragments which are less than a complete word (also referred to as tokens).

An exemplary use case is now described. The following describes implementation of at least one embodiment with respect to a bank's AI chat agent. The input message entered by the user (e.g., loaded context) is included in a conversation. The user enters the text “I'd like to know what my limits are.” The fragment repository includes the following textual fragments:
“Your transfer was successful”, “I can help you with”, “I cannot help you with”, “your inquiry”, “thank you”, “for”, “your current withdrawal limit is <LIMIT>”, as well as linking fragments such as periods, commas, etc . . . The generative model (e.g., the trained fragment predictor component of the generative model and/or in communication with the generative model), being constrained to only select coherent fragments in keeping with the loaded context, generates one of the following composite responses:
“Thank you for your inquiry. Your current withdrawal limit is <LIMIT>”
“I can help you with your inquiry. Your current withdrawal limit is <LIMIT>”
“Your current withdrawal limit is <LIMIT> Thank you.”
(less likely but possible): “I cannot help you with your inquiry”

It is noted that, in this example, while the exact generated composite response is a function of probabilities and includes an inherent element of uncertainty, this uncertainty is limited, and dynamically controlled by the fragments stored in the fragment repository. For example, the generative model cannot respond to the customer's inquiry (“I'd like to know what my limits are”) with more diverse responses such as, “You are limitless!”, “There are no limits to your imagination”, “In life, it is important to find opportunities to stretch one's limits”, and so forth, all of which are common examples of “hallucinations” generated by LLMs. At worst, the generative model may generate the response “I cannot help with your inquiry,” which, while sub-optimal in terms of the user-experience, does not expose the operator to legal and/or reputational risks.

At least one embodiment described herein relates to controlling text and/or voice-audio content generation using generative artificial intelligence. At least one embodiment may be implemented with respect to AI-powered conversational systems that generate text responses for display and/or voice-audio responses for speech synthesis. A predictive model iteratively selects from a curated set of pre-approved text fragments, directed by contextual information, continuing until a termination condition is met (e.g., selecting a STOP fragment and/or reaching a maximum fragment limit). The selected fragments are assembled into a cohesive response. Fragments may include parameterized variable placeholders that are resolved at generation time from contextual data sources, enabling dynamic personalization while maintaining compliance with pre-approved response structures. Fragments may be stored with associations to contextual cues, for example, behavioural guidelines, topics, user journeys, and/or external data integrations—enabling the system to dynamically filter which fragments are available to the predictive model based on active contextual cues. This approach ensures compliant, personalized, context-appropriate responses across text-based chatbots, voice assistants, and/or other AI-driven communication channels.

At least one embodiment described herein relates generating controlled text and voice-audio content using generative artificial intelligence, and more particularly to systems that constrain AI outputs to pre-approved text fragments while enabling dynamic personalization and context-aware filtering. At least one embodiment may be applicable to any AI system that generates natural language output, whether rendered as text for visual display (e.g., in chatbots, messaging applications, email, or web interfaces) and/or converted to voice-audio through text-to-speech synthesis (e.g., in voice assistants, interactive voice response systems, or audio-enabled applications).

At least one embodiment described herein uses a predictive model that processes contextual information together with a curated set of predefined text fragments, constrains the fragment predictor to select outputs exclusively from the predefined set, and allows fragments ranging from individual words to complete paragraphs. Multiple fragments are selected in sequence until a STOP fragment or maximum limit is reached. The fragments are assembled into a cohesive response, for example, via a CompletionGenerator component. A controllable axis between context-adaptability (through smaller fragments) and output determinism (through larger fragments) may be provided.

Potential advantages of at least one embodiment include:
Controllable Response Generation: The iterative fragment selection process, with configurable termination conditions (STOP fragments, maximum limits), may provide precise control over response length and/or structure while maintaining natural language flow.
Adaptability-Determinism Tradeoff: By adjusting fragment granularity (from individual words to complete paragraphs), operators may tune the system along a spectrum from highly adaptive responses (smaller fragments, more selection steps) to highly deterministic responses (larger fragments, fewer steps).
Reduced Fragment Count: Parameterized fragments may eliminate the need to create separate fragments for each data variation, which may significantly reduce the number of fragments that must be curated and approved.
Improved Personalization: Dynamic placeholder resolution may enable personalized responses while maintaining compliance guarantees.
Context-Appropriate Responses: Contextual cue filtering may ensure fragments are (only) available when appropriate, improving both relevance and compliance.
Integration Awareness: External data integration cues may enable the system to use integration-specific fragments (only) when those integrations are connected and data is available.
Regulatory Compliance: By combining pre-approved fragments with contextual filtering, entities (e.g., organizations) may help ensure responses meet regulatory requirements for specific contexts (e.g., HIPAA for healthcare, banking disclosures for financial services).
Operational Efficiency: Topics and/or user journey cues may enable more targeted fragment selection, which may reduce the computational load on the fragment predictor and/or may improve response quality.
Hallucination Prevention: Since the composite response is derived exclusively from pre-approved fragments, the system may eliminate or significantly reduce the risk of AI-generated hallucinations, making it suitable for regulated industries.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

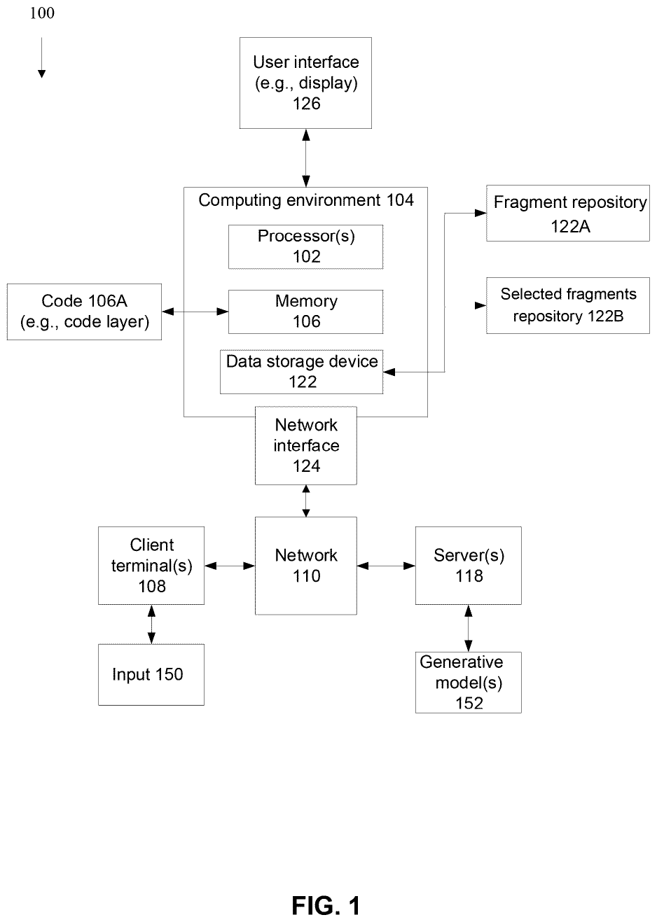

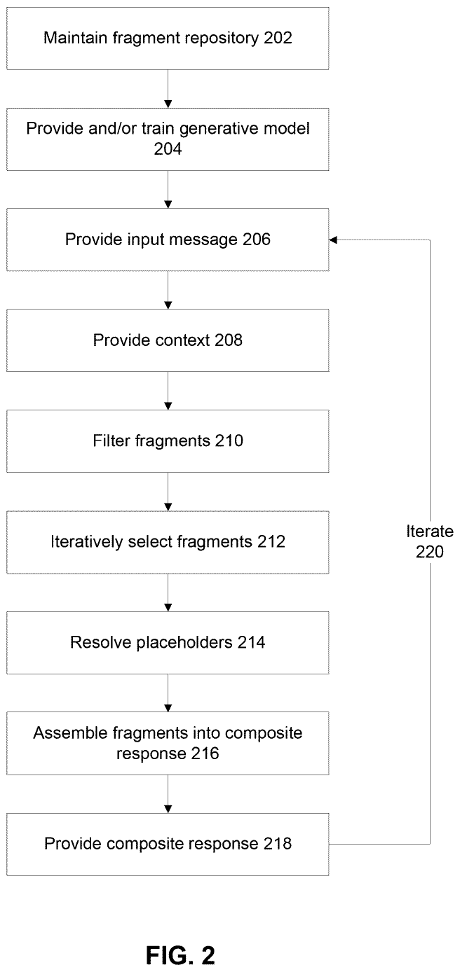

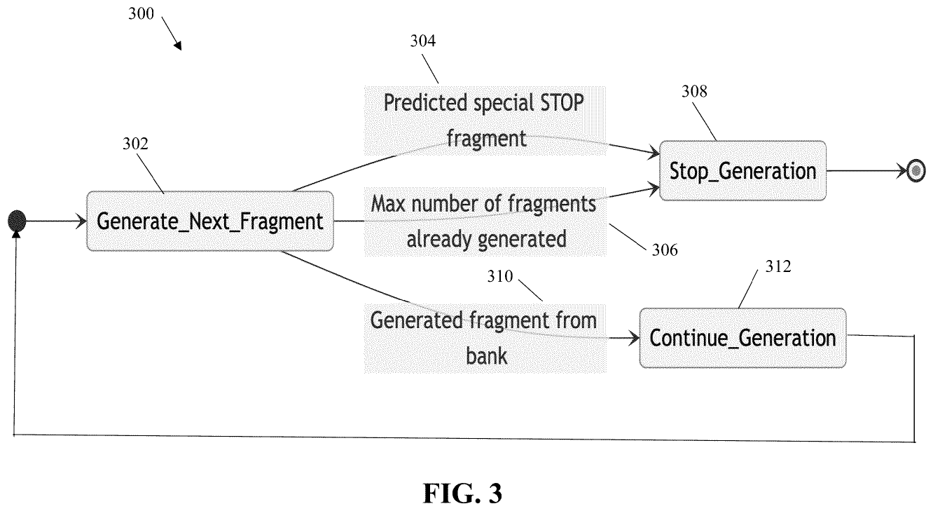

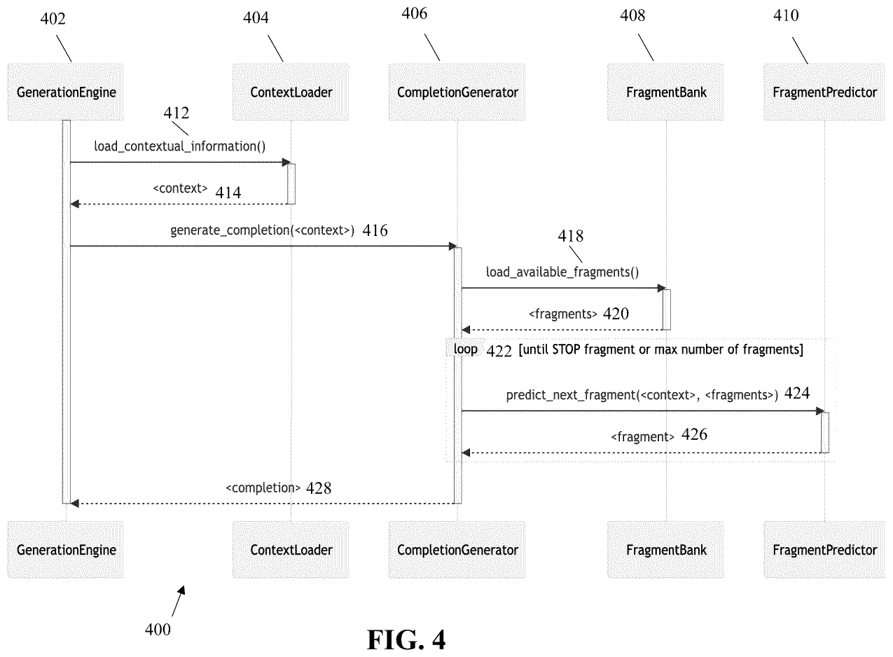

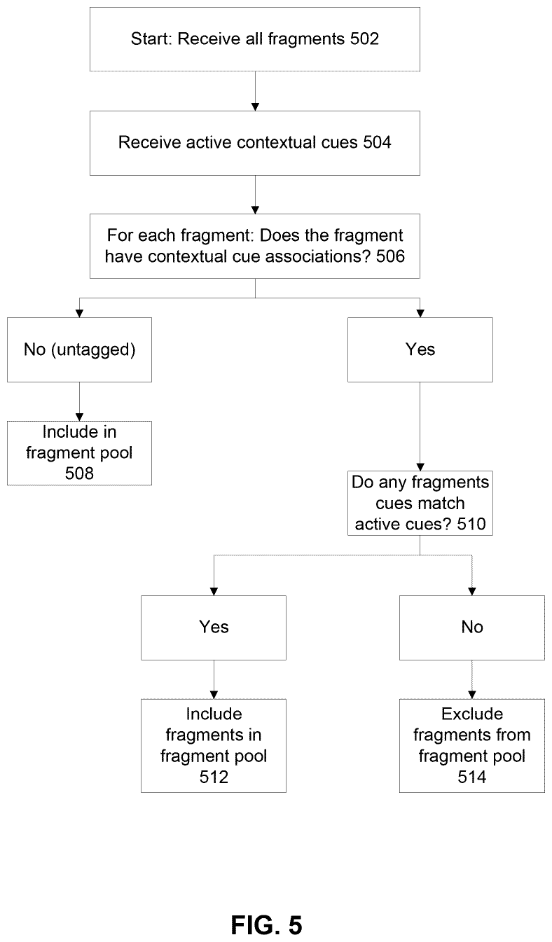

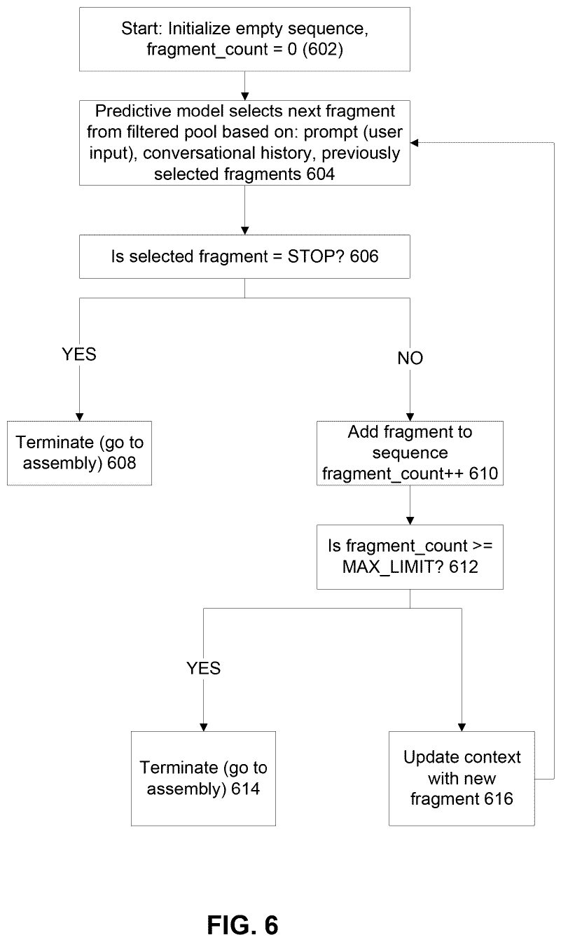

Reference is now made to FIG. 1, which is a block diagram of components of a system 100 for operating a generative model(s) that generates content excluding hallucinations, in accordance with some embodiments of the present invention. Reference is also made to FIG. 2, which is a flowchart of a method of operating a generative model(s) that generates content excluding hallucinations, in accordance with some embodiments of the present invention. Reference is also made to FIG. 3, which is a dataflow diagram 300 depicting an exemplary dataflow for dynamic selection of fragments for generation of a composite response in response to an input message, in accordance with some embodiments of the present invention. Reference is also made to FIG. 4, which is a sequence diagram 400 for operating a generative model(s) that generates content excluding hallucinations, in accordance with some embodiments of the present invention. Reference is also made to FIG. 5, which is a flowchart of an exemplary process for filtering fragments of the fragment repository based on contextual cues, in accordance with some embodiments of the present invention. Reference is also made to FIG. 6, which is a flowchart of an exemplary dataflow for dynamic selection of fragments for generation of a composite response in response to an input message, in accordance with some embodiments of the present invention.

System 100 may implement the acts of the method described with reference to FIGS. 2-6, by processor(s) 102 of a computing environment 104 executing code instructions stored in a memory 106 (also referred to as a program store).

Computing environment 104 may be implemented as, for example one or more and/or combination of: a group of connected devices, a client terminal, a server, a virtual server, a computing cloud, a virtual machine, a desktop computer, a thin client, a network node, and/or a mobile device (e.g., a Smartphone, a Tablet computer, a laptop computer, a wearable computer, glasses computer, and a watch computer).

Computing environment 104 may operate one or more generative model(s) 152 for generating content that excludes hallucinations in response to an input message 150(s) (e.g., entered by a user via a client terminal(s) 108) by selecting text fragments (e.g., hosted in a selected fragment repository 122B) from a fragment repository 122A.

Multiple architectures of system 100 based on computing environment 104 may be implemented. For example:

Computing environment 104 executing stored code instructions 106A, may be implemented as one or more servers (e.g., network server, web server, a computing cloud, a virtual server) that provides centralized services for operating one or more generative models 152 (e.g., one or more of the acts described with reference to FIGS. 2-6) for generating content that excludes hallucinations in response to input message(s) 150. Services may be provided, for example, to one or more client terminals 108 over network 110 (e.g., which may provide input message(s) 150 to the generative model 152), and/or to one or more server(s) 118 over network 110 that may host one or more generative models 152. Alternatively, generative model(s) 152 may be hosted by computing environment(s) 104 with optional access by server(s) 118, for example, via a virtual interface such as an application programming interface (API) and/or software development kit (SDK). Services may be provided by computing environment 104 to client terminals 108 and/or server(s) 118, for example, as software as a service (SaaS), a virtual and/or software interface (e.g., API, SDK), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web sited hosted by computing environment 104. For example, a user uses client terminal 108 to enter input message 150 into generative model 152 hosted by server 118. Generative model 152 may be run as an accessory to another application, for example, a user accesses a banking website, and enters an input into a helper robot which is run in the background by generative model 152. Generative model 152 generates a composite response by assembling text fragments exclusively obtained from fragment repository 122A. The composite response generated by generative model 152 in response to input message 150, which excludes hallucinations, may be presented on a display of client terminal 108.

In another example, computing environment 104 may be implemented as a standalone device (e.g., kiosk, client terminal, smartphone) that include locally stored code instructions 106A that implement one or more of the acts described with reference to FIGS. 2-6, for locally operating generative model(s) 152 that generates a composite response by assembling text exclusively obtained from fragment repository 122A, thereby excluding hallucinations, in response to input message(s) 150. Input message 150 may be locally entered, for example, by a user using a user interface (e.g., graphical user interface (GUI)) presented on a display of the standalone device. Input message 150 may be fed into generative model 152, which may be locally hosted by computing environment 104, for example, locally stored on and/or run by the smartphone. The locally stored code instructions 106A may be obtained from a server, for example, by downloading the code over the network, and/or loading the code from a portable storage device, such as by installing an app on a smartphone of a user. Generative model 152 generates content excluding hallucinations, which may be presented on the display of the standalone device, for example, within the user interface (e.g., GUI).

It is noted that generative model(s) 152 may be hosted, for example, by a data storage device 122 of computing environment 104, and/or remotely located such as hosted by a server and in communication with computing environment 104 over a network 110 (e.g., via a virtual interface such as API and/or SDK).

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-6 when executed by hardware processor(s) 102.

Computing environment 104 may include a data storage device 122 for storing data, for example, fragment repository 122A storing text fragments at least of an individual word size, and/or selected fragments repository 122B storing fragments selected from fragment repository 122A which are assembled into the composite response, as described herein. Data storage device 122 may be implemented as, for example, a memory, a local hard-drive, virtual storage, a removable storage unit, an optical disk, a storage device, and/or as a remote server and/or computing cloud (e.g., accessed using a network connection).

Network 110 may be implemented as, for example, the internet, a local area network, a virtual network, a wireless network, a cellular network, a local bus, a point-to-point link (e.g., wired), and/or combinations of the aforementioned.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing environment 104 and/or client terminal(s) 108 include and/or are in communication with one or more user interfaces 126 which may be designed to enable a user to enter input message 150 and/or to view the context excluding hallucinations generated by generative model(s) 152 in response to input message 150. Exemplary user interfaces 126 include, for example, one or more of, a touchscreen, a display, gesture activation devices, a keyboard, a mouse, and voice activated software using speakers and microphone.

Referring now back to FIG. 2, at 202, a fragment repository may be maintained.

The fragment repository may represent a dynamic, curated, and/or pre-approved set of fragments.

The fragment repository includes (e.g., hosts and/or stores) multiple predefined text fragments. Each individual text fragment includes at least a complete word. The fragment repository may exclude individual text fragments smaller than a complete word, such as partial

words and/or tokens may be excluded from the fragment repository. The fragment repository includes, for example: individual words, phrases, complete sentences, partial paragraphs, complete paragraphs, partial text items including one or more paragraphs, and complete text item including one or more paragraphs.

The fragment repository may include non-text elements, for example: a new line marker, one or more different types of punctuation marks, and at least one formatting element. The non-text elements may control response structure without adding semantic content.

There may be one or more different types of fragment repositories. Each fragment repository may be customized, for example, for a domain, entity, application, and the like. For example, one fragment repository is designed for a customer service bot of a bank. Another fragment repository is designed to help users book their flights on an airline website. Yet another fragment repository is designed to help users find information on a government website that provides multipole different types of services to citizens.

The fragment repository represents the set of text fragments which are selected and assembled to generate a composite response to an input message, optionally in a specific domain. Curation of the fragment repository, by including allowable text fragments and excluding irrelevant and/or erroneous text fragments prevents or significantly reduces risk of including hallucinations in the composite response.

Optionally, the fragment repository may be manually created and/or manually reviewed and/or manually edited by a user, optionally via a user interface (e.g., graphical user interface (GUI)) presented on a display designed for one or more of the aforementioned tasks. For example, the GUI may present the current fragments in the fragment repository with a navigation interface (e.g., icons, selectable items, boxes for manual text entry), for example, for searching the fragments, sorting the fragments (e.g., by length, by type such as single words or sentences, alphabetically, and the like), creation of new fragments, deletion of existing fragments, and editing of existing fragments.

Alternatively or additionally, the fragments included in the fragment repository may be automatically generated. The automatic generation may be performed by feeding instructions (e.g., using a different input message different than the input message fed into the generative model) into another generative model (e.g., LLM). The instructions may include instructions to automatically generate the fragment repository for a specific domain. For example, “Generate text fragments each at least one full word in length for the domain of assisting a user on a banking website, where the text fragments exclude content unrelated to banking”. The other generative model may automatically generate the fragments according to at least one selection generation parameter. The selection generation parameter(s) may indicate a tradeoff between smaller sized fragments enabling greater context-adaptability, and larger sized fragments indicating increased output determinism. In another example, the selection generation parameter(s) may indicate a tradeoff between increased number of fragments enabling greater context-adaptability, and decreased number of fragments increasing output determinism.

Optionally, another set of instructions may be generated to instruct the other generative model (that generated the set of text fragments) to check the automatically generated fragment repository for text fragments likely to lead to unintended and/or non-compliant responses. For example, to identify text fragments unrelated to the current domain, which are non-specific, and/or which may be misinterpreted.

Fragments may include parameterized variable placeholders that are resolved (i.e., filled in) at selection and/or assembly (e.g., generation time) from contextual data sources. The placeholders may eliminate or reduce the need for separate fragments for each data variation.

Without the parameterized variable placeholders, each unique response may require a separate pre-approved fragment. For example, to communicate account balances to customers, an operator would need to create and approve fragments such as:
“Your account balance is $100”
“Your account balance is $200”
“Your account balance is $1,234.56”

This approach becomes impractical when dealing with dynamic data that can take many values. The parameterized fragments, i.e., fragments including parameterized variable placeholders, for example, denoted by a syntax such as ‘{{variable_name}}’, address and/or solve this technical problem. For example: “Your account balance is {{balance}}”

During selection and/or assembly of the fragments (e.g., at generation time), before the fragment is outputted in the composite response, placeholders may be resolved from contextual data sources, for example, conversation variables, user profile data, session state, and/or system-provided values.

Fragments may be stored with associations to contextual cues, for example, behavioural guidelines, topics, user journeys, and/or external data integrations. The contextual cues may enable dynamic filtering which fragments are available to the generation model (e.g., and/or predictive model) based on active contextual cues. The contextual cues may be implemented as metadata. The contextual cues may help define associations for determining whether the fragment is appropriate for being selected.

Examples of contextual cues include:
Behavioural guidelines: Rules governing agent behaviour, for example, “HIPAA compliance”, “banking disclosure”, “no-refund policy”.
Topics: Subject matter categories, for example, “billing”, “technical support”, “product inquiry”.
User journeys: Stages in a customer interaction flow, for example, “onboarding”, “renewal”, “cancellation”.
External data integrations: Connections to external systems, for example, “CRM”, “order management system”, “payment gateway”.

The fragment repository may be implemented as, for example based on a relational database structure, a vector database with embeddings, and/or a hierarchical graph structure. Some exemplary architectures of the relational database structure include a fragments table having columns, a metadata table having columns, and/or a fragment_relationships table having columns. The fragment repository may include indexed fields to optimize query performance during fragment selection operations. The vector database may implement similarity search functionality using distance metrics, for example: Cosine similarity (measuring angular distance between embedding vectors), Euclidean distance (measuring straight-line distance in embedding space), and/or Dot product (measuring vector alignment). Fragment selection may be performed using the vector database as follows: generating an embedding vector for the text input message using the same embedding model used for fragment embeddings. Performing a search (e.g., k-nearest neighbor (k-NN)) in the vector database to identify a candidate set of fragments having embedding vectors within a predetermined similarity threshold to the input message embedding. Filtering the candidate set based on metadata constraints including domain_classification matching and compliance_verified status. Ranking filtered candidates by similarity score. Selecting fragments from the ranked candidates for assembly into the composite response. Some exemplary architectures of the directed acyclic graph (DAG) include: nodes representing individual text fragments, and edges representing permissible transitions between fragments. Fragment selection may be performed using the DAG as follows: identifying a starting node based on semantic matching between the input message and ROOT or INTERMEDIATE node fragments. Traversing edges from the current node based on: transition_weight values, context_requirements satisfaction, and history of previously selected fragments. Selecting the target_node_id of the traversed edge as the next fragment. Repeating the traversing and selecting steps until reaching a TERMINAL node or satisfying a termination condition. Assembling the sequence of selected node fragments into the composite response. The graph structure may be stored in a graph database with graph traversal processes implemented, for example, using breadth-first search (BFS), depth-first search (DFS), or A* pathfinding with heuristics based on semantic relevance to the input message.

At 204, a generative model is provided and/or trained.

Optionally, the generative model is a pre-trained model, trained on a training dataset that includes text external to the fragment repository. The generative model may be operated as described herein, to assemble the composite response from fragments selected from the fragment repository based on the training from the text external to the fragment repository. The training dataset used to train the generative model may be a generic training dataset that includes text from different domains, including text from domains different than the domain of the fragment repository.

The generative model may be implemented as natural language processing (NLP) model designed to receives an input of a natural language text input message (e.g., manually entered by a user) and generate an output of natural language text content (e.g., for a user to read or listen to). The NLP model may be implemented as, for example, a large language model (LLM) or a classifier. The generative model may be implemented as a neural network based architecture, for example, one or combination of the following neural network based architectures: convolutional, fully connected, deep, encoder-decoder, recurrent, transformer, and graph.

Alternatively or additionally, the generative model may be pre-trained on a specific training dataset that includes text within the fragment repository and/or within the domain of the fragment repository.

Alternatively or additionally, the generative model may be a pre-existing model, which is placed in communication with one or more additional components that select the text fragments and/or assemble the selected text fragments into the composite response. Such architecture enables providing different existing generative models with the feature or reducing or preventing hallucinations in responses generated by the generative model. Exemplary additional components are described, for example, with reference to FIG. 4.

The communication between the pre-existing generative model and the additional components may be implemented, for example, using one or more of:
RESTful API calls with JSON payloads containing input messages, generation parameters, and constraint specifications.
gRPC protocol for lower-latency streaming of tokens during generation.
WebSocket connections for bidirectional real-time communication.
Direct function calls when the additional components are implemented as a wrapper library around the pre-existing generative model's inference engine.

In an exemplary implementation, the additional components may operate by:
Accessing the pre-existing generative model's logit output layer (e.g., a tensor of shape [batch_size, vocabulary_size]);
Constructing a binary mask tensor of identical shape, with values of 1 for allowed tokens and 0 for disallowed tokens;
Applying the mask by: logits_masked=logits_original+(1−mask)*(−1e9), effectively removing disallowed tokens from consideration;
Returning logits_masked to the generative model's sampling mechanism (e.g., top-k, top-p, or temperature-based sampling).

The aforementioned architecture enables retrofitting existing LLM deployments with hallucination prevention capabilities without requiring retraining of the base model, thereby providing a practical implementation for entities with established LLM infrastructure.

At 206, an input message, optionally text, is provided (e.g., received and/or accessed).

The text input message may be entered by a user via a user interface (e.g., GUI) presented on a display of a client terminal. For example, the user may type the text input message into an interactive conversation window presented on the display. In another example, the user may speak into a microphone, and the text input message may be automatically generated by an audio to text conversion process.

It is to be understood that text entered by a user via a user interface may be pre-processed and/or transformed into the input message.

The input message may include a current user message entered into the user interface, for example, the current text entered by a user during an ongoing conversation. Alternatively or additionally, the input message may include a conversation history, such as one or more recent text entered by a user during the conversation, prior to previously generated responses by the generative model.

At 208, context, including active contextual cues (also referred to as contextual information) associated with the input message is dynamically provided (e.g., extracted and/or accessed and/or computed). The contextual information associated with the input message may correspond to the contextual information associated with the fragments stored in the fragment repository. Examples of contextual information include: user input, conversation history, and response hints. The active contextual cues may be determined, for example, based on conversation state, user attributes, connected integrations, regulatory requirements, etc. Optionally, the active contextual cues for the current input message is obtained prior to fragment selection.

In some embodiments, the active contextual cues associated with the input message are obtained by a dedicated context loader that aggregates and/or normalizes information from multiple sources into a unified context representation. The context loader may first analyze the current user utterance and recent conversation history using one or more classifiers or tagging models (e.g., intent classifiers, topic classifiers, sentiment detectors, journey-stage classifiers) to infer high-level labels such as “account_inquiry,” “cancellation_request,” “technical_support,” or “appointment_scheduling.” In parallel, the context loader may query session state and user profile data (e.g., user segment, products held, jurisdiction, language, risk tier) as well as the status of external integrations (e.g., whether a CRM, order management system, or payment gateway is currently connected and returning valid data). Regulatory and policy engines can contribute additional cues based on factors such as geography (e.g., “GDPR_applicable,” “HIPAA_applicable”), channel (e.g., “voice_channel,” “chat_channel”), and use-case configuration defined by the operator. The resulting cues from these heterogeneous sources are merged, de-duplicated, and optionally prioritized (e.g., by assigning weights or precedence rules) to form the set of “active contextual cues” that is then supplied to the fragment filtering component and the fragment predictor for the current generation step.

At 210, the system may dynamically filter the fragments in the fragment repository to include fragments associated with the active contextual cue(s). The fragments selected post-filtering may be included in a fragment pool, from which individual fragments are selected.

Filtering fragments based on active contextual cues helps ensures that the selection is performed from contextually-appropriate fragments, which may improve relevance of the selected fragments and/or compliance (for reducing or eliminating hallucinations).

Optionally, global (e.g., untagged) fragments may be included. The filtered fragments may serve as the fragment repository from which individual fragments as selected as described herein. In the following features of the method, reference to the fragment repository may refer to the filtered fragments.

The filtering may be performed, for example, by matching contextual cues of fragments to the active contextual cue(s) associated with the input message, by computing a correlation value between contextual cues of fragments and the active contextual cue(s) associated with the input message and selecting fragments with correlation value above a threshold, and/or by computing a statistical distance (e.g., Euclidean, cosine) between contextual cues of fragments and the active contextual cue(s) associated with the input message and selecting fragments with distance below another threshold.

An exemplary process for filtering fragments of the fragment repository based on contextual cues is described, for example, with reference to FIG. 5.

At 212, a set of text fragments is selected from the fragment repository based on the text input message. The set of text fragments may be selected from the fragment pool that includes fragments filtered from the fragment repository based on the active contextual cue(s).

Each text fragment included in the set is exclusively selected from the fragment repository. The set of text fragments excludes text fragments which are not included in the fragment repository.

The set of text fragments may be selected, by iteratively selecting a single (or more) text fragment during each iteration of multiple iterations. The iterations of sequentially selecting the single text fragment at a time until a termination condition is met. After each selection, the system may check whether the terminal condition is met. The termination condition may be implemented as, for example, selection of a stop fragment, and/or reaching a predefined maximum number of text fragments in the set and/or reaching a maximum total length of the text fragments in the set.

Optionally, the set of text fragments are dynamically selected as a sequence, where each subsequent text fragment is selected and/or predicted according to the preceding text fragments in the existing sequence.

An exemplary dataflow and/or process for iterative selection of text fragments is described, for example, with reference to FIG. 3 and/or FIG. 6.

The iterative selection of the text fragments may be performed based on a prediction of a next text fragment in view of the input message. The prediction of the next text fragment may be based on a history of the preceding selected text fragments (being selected in response to the input message).

The selection and/or prediction may be performed, for example, by the generative model, and/or by one or more components integrated within the generative model and/or in communication with the generative model. For example, a generation engine may be designed to perform and/or orchestrate the iterative selection of the set of fragments. In another example, a trained fragment predictor may be designed to predict a next fragment for selection exclusively from the fragment repository in view of the input message and/or in view of fragments selected in preceding iterations.

Exemplary components of the generative model and/or in communication with the generative model are described, for example, with reference to FIG. 4.

The iterative approach may provide a controllable axis between context-adaptability and output determinism. Smaller fragments (e.g., words, short phrases) may allow more adaptive, varied responses but require more selection steps. Larger fragments (e.g., sentences, paragraphs) may provide more deterministic outputs with fewer selection steps. The controllable axis may be dynamically adjusted by the selection generation parameter(s) (e.g., by a user via the user interface and/or automatically by code to obtain a target performance).

Optionally, the set of fragments is selected based on the contextual information associated with the input message. The set of fragments may be dynamically filtered using fields of a database hosting the fragments matching the contextual information.

In some embodiments, the fragment predictor model (and/or fragment predictor component of the generative model) may be implemented as a lightweight sequence model that operates over fragment identifiers rather than raw subword tokens. For example, the predictor may be realized as a transformer encoder-decoder, a recurrent neural network (RNN), or a gated recurrent unit (GRU) network that receives, as input at each time step, (i) an embedding of the current conversational context (e.g., an embedding of the input message and recent dialogue turns), (ii) embeddings of previously selected fragments in the current sequence, and optionally (iii) an embedding of the active contextual cues. Each fragment in the fragment repository may be assigned a unique fragment ID, and a trainable fragment embedding matrix maps fragment IDs to dense vectors. The predictor model may output a probability distribution over the finite set of fragment IDs in the repository, constrained further at run time to the currently active filtered fragment pool. The predictor model may include additional conditioning channels for scalar control parameters (e.g., a “determinism” or “verbosity” scalar) that are concatenated or added to hidden states to modulate the trade-off between using shorter vs. longer fragments.

Training data for the fragment predictor model may be constructed by taking existing compliant conversational logs and/or documentation within the target domain and automatically segmenting these texts into fragments that correspond to entries in the fragment repository. For each training conversation, the system can generate multiple training examples in which the input includes the input messages (e.g., user utterance(s)), optional conversation history, and/or the ground-truth sequence of fragment IDs that reconstructs the approved answer. A supervised learning objective such as cross-entropy loss over the fragment ID sequence may be used, optionally augmented with auxiliary losses that encourage selection of higher-granularity (longer) fragments when appropriate and/or penalize overly long sequences. In some embodiments, the predictor model may be initialized from a pre-trained language model by reusing its transformer layers and replacing the final token-level softmax with a fragment-level softmax, thereby leveraging generic language understanding while constraining generation to fragment IDs only.

At 214, optionally, the set of fragment are processed to resolve placeholders. Optionally, the set of fragments is dynamically evaluated to resolve placeholders as the set (e.g., sequence) of fragments is dynamically grown by iterative selection. Alternatively or additionally, the set of fragments is evaluated to resolve placeholders upon termination of the iterations, once the final set has been selected. Alternatively or additionally, each fragment is dynamically evaluated to resolve placeholders during selection of the fragment.

Non-resolvable fragments may be excluded from being selected and excluded from the set. In response to a failure of dynamically resolving parameterized variable placeholder(s) of candidate text fragment(s) using the contextual data sources, the candidate text fragment(s) is excluded from being selected for including in the set of text fragments which are assembled into the composite response. Excluding non-resolvable fragments from being selected reduces risk of, or eliminates, the generation of hallunications.

An exemplary placeholder resolution process is now described: Parse the fragment text to identify the variable placeholders. For each placeholder, look up the corresponding value in the context data. Substitute each placeholder with its resolved value. When any placeholder cannot be resolved, the fragment may be excluded from selection and/or from the set. Excluding fragments with unresolved placeholders may prevent generation of false claims (e.g., reduce risk of hallucinations). For example, when the system, working within a banking context, is assisting a user in disputing a transaction on their credit card, the fragment selection process runs the risk of saying, “The dispute has been filed successfully,” even when it wasn't. However, by placing a placeholder, “The dispute (id={{dispute_id}}) has been filed successfully”, the exclusion of fragments with unresolved placeholders helps ensure that the fragment will not (e.g., never, or significantly reduces the risk of) be selected and displayed to the user unless a data source has reliably introduced this variable into the context.

An exemplary flow for placeholder resolution is now described:
Input: Fragment with placeholders. For example, “Your order {{order_id}} shipped on {{ship_date}} via {{carrier}}”.
Parse placeholders. For example, [“order_id”, “ship_date”, “carrier”].
Context data available: For example: {order_id: “ORD-12345”, ship_date: “Jan. 15, 2025”, carrier: “FedEx”}
For each placeholder: Look up value in the context data, and substitute in the corresponding fragment.
Output: resolved fragment. For example, “Your order ORD-12345 shipped on Jan. 15, 2025 via FedEx”.

At 216, the set of selected text fragments are assembled into a composite response.

The assembly of the composite response may be performed by the generative model and/or components that perform the prediction and/or selection of the text fragments. Alternatively or additionally, the assembly of the composite response may be performed by a different generative model, that is different than the generative model and/or components that perform the prediction and/or selection of the text fragments.

In embodiments in which the text fragments are dynamically selected into a growing sequence, the composite response is dynamically assembled as additional selected text fragments are iteratively added to the sequence. In embodiments in which the text fragments are selected without respect to an ordered sequence, the composite response may be generated by arranging the selected set of text fragments. The composite response is exclusively generated from the selected set.

The assembly may be performed, for example, by the generative model and/or by a completion generator component of the generative model and/or in communication with the generative model, and/or other components.

The assembly may be performed, for example, by automatically generative and/or accessing a predefined assembly input message instructing the generative model (or other component) to generate the composite response as a response to the input message (provided in 206) by implementing the assembling without including additional text external to the fragment repository.

The generated composite response has significantly reduced or eliminated unintended and/or non-compliant responses, for example, significantly reduced and/or eliminated hallucinations, incorrect content, unverifiable content, unintended content, untimely content and/or incoherent content.

The significant reduction or elimination of the unintended and/or non-compliant responses may be in comparison to another composite response which would be generated by the generative model or another generative model designed to generate responses without exclusively assembling fragments selected from the fragment repository. For example, an existing LLM trained to generally respond to input messages.

The amount of the significant reduction or elimination of the unintended and/or non-compliant responses in comparison to the other generative model may be, for example, at least about 60%, or 70%, or 80%, or 90%, or 95%, or 99%, or other values.

In an example, the selected fragment sequence is [“Hello, ”, “your balance is {{balance}}”, STOP]. Placeholders are resolved from contextual data, as described herein. The resolved fragments are: [“Hello, ”, “your balance is $1,234.56”]. The assembled composite response is: “Hello, your balance is $1,234.56”.

The completion generator (i.e., the assembler that performs the assembly) and/or component of the generative model that performs the assembly may be implemented as, for example, a deterministic post-processing process rather than a generative model per se. In one embodiment, the assembler receives the ordered list of fragment IDs and retrieves the associated fragment texts, applies placeholder resolution using a context data structure (e.g., a key-value store populated by external systems or prior conversation turns), and then performs rule-based formatting. Formatting may include insertion of explicit NEW_LINE and punctuation fragments, normalization of whitespace, capitalization of the first character of the composite response, and removal or rewriting of duplicate or conflicting fragments according to declarative layout rules. In an alternative embodiment, the assembler is itself is implemented as a neural network model that takes as input the unordered or partially ordered set of selected fragments and outputs an ordering and minimal connective text (e.g., conjunctions or pronouns), subject to a hard constraint that any non-fragment text must come from a separate, tightly bounded “connector fragment” bank that has been independently approved.

In some embodiments, both the predictor model and assembler model may be jointly optimized. For example, a differentiable assembler layer may concatenate fragment embeddings and pass them through a small transformer or convolutional network that predicts auxiliary quality scores (e.g., coherence, politeness, compliance likelihood). These scores can be included in a reinforcement learning objective in which the fragment predictor is rewarded for sequences that achieve a high compliance score while remaining concise. Policy-gradient or actor-critic methods can be used where the “action space” is the space of fragment IDs, and the “environment” is defined by the assembler and a downstream compliance classifier. This joint training can further bias the predictor to avoid fragment combinations that, though individually approved, are known to interact poorly or lead to ambiguous statements.

At 218, the composite response is provided. The composite response may be provided for presentation within the user interface (e.g., GUI) on the display of the client terminal. The composite response may be presented within the conversational window as the current response to the most recent input message provided by the user. Alternatively or additionally, the composite response may be fed into an audio process that synthesizes speech played over speakers. In yet another example, the composite response may be forwarded to data storage device for storage. In yet another example, the composite response may be fed into another executing process. For example, into an AI-agent designed to automatically execute tasks according to the composite responses generated by the generative model. For example, the user asks “How do I buy 100 shares of stock XYZ?” The generative model generates a response. The AI-agent may automatically make the purchase based on the response.

At 220, one or more features described with reference to 206-218 may be iterated during a conversation held by the user with the generative engine, optionally within the user interface. Each iteration may be triggered in response to another input message entered by the user.

Referring now back to FIG. 3, at 302, a next fragment is predicted.

At 304, a STOP fragment is predicted.

Alternatively, at 306, a maximum number of fragments have already been generated.

At 308, following 304 or 306, a stop generation indication is reached. The composite response is generated using the fragments predicted during the preceding iterations.

Alternatively to 304 and 306, at 310, another fragment is generated (i.e., selected) from the fragment repository.

At 312, following 310, another iteration for generation of fragments is implemented, by returning to 302.

Referring now back to FIG. 4, dataflow diagram 400 depicts an exemplary dataflow between the following exemplary components, which may be integrated within the generative model and/or may be external components in communication with the generative model (e.g., via API, function calls, and/or other virtual interfaces): a generation engine 402, a context loader 404, a completion generator 406, a fragment bank (also referred to herein as fragment repository) 408, and a fragment predictor 410.

At 412, generation engine 402 sends instructions to context loader 404 to load the context, also referred to herein as input message. For example, to extract the context from a user interface presented on a display of a client terminal used to present an interaction between a user and the generative model.

At 414, context loader 404 provides the context to generation engine 402.

At 416, generation engine 402 sends the context to completion generator 406, for instructing completion engine 406 to generate a composite response to the context.

At 418, completion generator instructs fragment bank 408 to provide text fragments.

At 420, completion generation receives the text fragments from fragment bank 408. The received text fragments are loaded into a memory.

At 422, a loop of 424 and 426 may be iterated until a termination condition is met. The terminal condition may include generation of a stop fragment, and/or reaching a maximum number of fragments.

At 424, completion generator 406 instructs fragment predictor 410 to predict a next fragment from the fragments loaded into the memory according to the provide context.

At 426, the fragment predictor predicts the next fragment.

At 428, completion generation sends an indication that selection of a set of fragment has completed. The set of fragments is assembled into the composite response, which is provided for presentation within the user interface. The assembly may be performed, for example, by the generative model, generation engine 402, completion generator 406, and/or another component.

Referring now back to FIG. 5, the flowchart of the exemplary process for filtering fragments of the fragment repository based on contextual cues, is provided. in accordance with some embodiments of the present invention. One or more features of the process described with reference to FIG. 5 may be integrated with and/or combined with, and/or serve as alternative to, one or more embodiments described herein, for example, with reference to FIG. 2 and/or FIG. 4.

At 502, fragments in the fragment repository are accessed. Optionally, all fragments in the fragment repository are accessed. For example, the fragments are loaded into a memory.

At 504, one or more active contextual cues are accessed and/or extracted. The active contextual cues are associated with the received input message.

At 506, each fragment is evaluated to determine whether the fragment has any contextual cue associations.

At 508 (NO), fragments without any contextual cue associations, which denote global fragments to always be included, are added to a fragment pool from which individual fragments are to be selected.

Alternatively, at 510 (YES), fragment context cues are compared to the active contextual cues to determine a match. The comparison may be done using other approaches, for example, computing a correlation value above a threshold, and/or computing a statistical distance (e.g., Euclidean) below a threshold.

At 512 (YES), fragments with context cues matching the active contextual cues are added to the fragment pool from which individual fragments are to be selected.

Alternatively, at 514 (NO), fragments with context cues that do not match the active contextual cues excluded from the fragment pool from which individual fragments are to be selected.

Referring now back to FIG. 6, the flowchart of the exemplary dataflow for dynamic selection of fragments for generation of a composite response in response to an input message, is provided. One or more features of the process described with reference to FIG. 6 may be integrated with and/or combined with, and/or serve as alternative to, one or more embodiments described herein, for example, with reference to FIG. 3 and/or FIG. 4.

At 602, An empty sequence may be initialized. A fragment_count may be initialized, for example, to zero.

At 604, a predictive model (and/or the generative model) selects a next fragment, optionally from the filtered pool (or from the fragment repository when no filtering is implemented), based on, for example, the input message (e.g., user input), conversational history, and/or previously selected fragments.

At 606, the selected fragment is evaluated to determine whether the selected fragment is a stop fragment.

At 608, in response to YES, the selection process is terminated. The method proceeds to assembling the selected fragments as described herein.

Alternatively, at 610, the selected fragment is added to the sequence. The counter fragment_count may be incremented.

At 612, the value of fragment_count may be compared to a threshold denoted MAX_LIMIT.

At 614, in response to the value of fragment_count being greater than MAX_LIMIT, the selection process is terminated. The method proceeds to assembling the selected fragments as described herein.

Alternatively, at 616, in response to the value of fragment_count being greater than MAX_LIMIT, the selected fragment is added to the sequence of previously selected fragments, and the selection process iterates, and returns to 604.

Some additional exemplary embodiments are now described. Features of the additional embodiments described below may be combined with, and/or used as alternatively of, one or more embodiments described above.

At least one embodiment relates to a computer implemented method for generating controlled text or voice-audio content, comprising: storing a plurality of pre-approved text fragments, wherein fragments may include one or more variable placeholders, receiving contextual information including user input and/or context data, iteratively selecting fragments from the stored fragments using a predictive model, wherein the predictive model selects each fragment based on the contextual information and/or previously selected fragments, optionally, continuing until a termination condition is met, for each selected fragment containing variable placeholders, resolving said placeholders using values from the context data, and assembling the selected fragments into a cohesive response and outputting the response.

Optionally, the variable placeholders are denoted by a predefined syntax pattern within the fragment text.

Optionally, the context data includes one or more of: conversation variables, user profile data, session state, and/or system-provided values.

Optionally, a fragment including an unresolvable placeholder is excluded from selection by the predictive model.

Optionally, the termination condition includes one or more of: selection of a designated STOP fragment, reaching a maximum fragment count limit, and selection of a fragment marked as terminal.

At least one embodiment relates to a computer implemented method for generating controlled text or voice-audio content, comprising: storing a plurality of pre-approved text fragments, each fragment associated with zero or more contextual cues, receiving contextual information including user input and/or a set of active contextual cues for the current context, filtering the stored fragments to produce a filtered fragment pool including only fragments associated with active contextual cue and/or fragments with no contextual cue associations, iteratively selecting fragments from the filtered fragment pool using a predictive model, wherein the predictive model selects each fragment based on the contextual information and previously selected fragments, continuing until a termination condition is met, and assembling the selected fragments into a cohesive response and outputting the response.

Optionally, the contextual cues comprise one or more of: behavioral guidelines, topics, user journeys, or external data integrations.

Optionally, the active contextual cues are determined based on conversation state, user attributes, connected external systems, and/or regulatory requirements.

Optionally, each fragment is further associated with semantic signals, and the filtering additionally includes matching fragments based on semantic similarity to the user input.

At least one embodiment relates to a system for generating controlled text or voice-audio content, comprising: a fragment store containing pre-approved text fragments, wherein fragments may include variable placeholders and/or may be associated with contextual cues, a contextual cue filter configured to filter fragments based on active contextual cues, a fragment predictor configured to iteratively select fragments from the filtered pool based on contextual information and previously selected fragments, continuing until a termination condition is met, a placeholder resolver configured to substitute variable placeholders with values from context data, and/or a response assembler configured to assemble the selected fragments into a cohesive response.

Optionally, the termination condition includes one or more of: selection of a designated STOP fragment, reaching a maximum fragment count limit, and selection of a fragment marked as terminal.

Optionally, the contextual cues comprise one or more of: behavioral guidelines, topics, user journeys, or external data integrations.

Optionally, fragments are further associated with semantic signals enabling relevance-based filtering.

Optionally, the placeholder resolver excludes fragments with unresolvable placeholders from selection.

Optionally, the fragment store further contains system fragments including at least one of: STOP fragments for terminating generation, NEW_LINE fragments for controlling response structure, or punctuation fragments.

Some exemplary use cases are now described:

A first example relates to the domain of Financial Services.

Fragment stored: “Your balance is {{balance}} as of {{date}}. This may not reflect pending transactions.”

Contextual cue associations: guideline: “banking_disclosure”; topic: “account_inquiry”.

Context data: {balance: “$5,432.10”, date: “Jan. 15, 2025”}

Active contextual cues: [“banking_disclosure”, “account_inquiry”]

Generated response: “Your balance is $5,432.10 as of Jan. 15, 2025. This may not reflect pending transactions.”

Compliance benefit: The disclaimer text (“This may not reflect pending transactions”) is guaranteed to appear because it is part of the pre-approved fragment.

A second example relates to the domain of Healthcare.

Fragment stored: “Your appointment with {{provider}} is scheduled for {{date}} at {{time}}. Please bring your insurance card and a valid ID.”

Contextual cue associations: guideline: “hipaa_compliant”; journey: “appointment_scheduling”.

Context data: {provider: “Dr. Smith”, date: “Jan. 20, 2025”, time: “2:30 PM”}

Active contextual cues: [“hipaa_compliant”, “appointment_scheduling”]

Generated response: “Your appointment with Dr. Smith is scheduled for Jan. 20, 2025 at 2:30 PM. Please bring your insurance card and a valid ID.”

Compliance benefit: This fragment is only available when healthcare-related contextual cues are active, ensuring HIPAA-appropriate language is used.

A third example relates to the domain of E-commerce with External Integration.

Fragment stored: “Your order {{order_id}} shipped on {{ship_date}} via {{carrier}}. Track your package at {{tracking_url}}.”

Contextual cue associations: integration: “order_management_system”; topic: “order_status”.

Context data (from integration): {order_id: “ORD-98765”, ship_date: “Jan. 18, 2025”, carrier: “UPS”, tracking_url: “https://ups.com/track/1Z999 . . . ”}

Active contextual cues: [“order_management_system”, “order_status”]

Generated response: “Your order ORD-98765 shipped on Jan. 18, 2025 via UPS. Track your package at https://ups.com/track/1Z999 . . . ”

Integration benefit: This fragment is only available when the order management integration is connected, ensuring order-related responses are only generated when accurate data is available.

A fourth example is now provided. The forth example may represent an exemplary architecture and/or exemplary components and/or exemplary features/flow.

Context: (user message, conversation history, active contextual cues).

Fragment repository includes the following fragments and associated contextual cues:
Fragment: “Hello,”; Contextual Cues: [] (always available)
Fragment: “your balance is {{balance}}”; Contextual Cues: [banking_disclosure, account_inquiry]
Fragment: “as of {{date}}.”; Contextual Cues: [banking_disclosure]
Fragment: STOP (system fragment—terminates generation)

Contextual due filter:
Active cues: [banking_disclosure, account_inquiry].
Result: all matching fragments pass filter.

Iterative fragment predictor:
Iteration 1: Selects “Hello,”
Iteration 2: Selects “your balance is {{balance}}”
Iteration 3: Selects “as of {{date}}.”
Iteration 4: Selects STOP-->[TERMINATE]
Selected sequence: [“Hello,”, “your balance is {{balance}}”, “as of {{date}}.”, STOP]

Placeholder resolver:
Context: {balance: “$1,234.56”, date: “Jan. 15, 2025”}
Resolves placeholders in each fragment

Response Assembler:
Assembles: “Hello,”+“your balance is $1,234.56” “+as of Jan. 15, 2025.”
Final output: “Hello, your balance is $1,234.56 as of Jan. 15, 2025.”

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant generative models will be developed and the scope of the term generative model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of controlling a response by a generative model, comprising:
using at least one processor for:
receiving an input message;
maintaining a fragment repository comprising a plurality of predefined text fragments, wherein each text fragment includes at least a complete word;
iteratively selecting, by the generative model, a set of text fragments from the fragment repository based on the input message,
assembling, by the generative model, the set of selected text fragments into a composite response; and
providing the composite response for presentation within a user interface on a display of a client terminal.

2. The computer implemented method of claim 1, wherein the composite response has significantly reduced unintended and/or non-compliant responses in comparison to a second composite response generated by a second generative model configured to generate a complete response without accessing the fragment repository.

3. The computer implemented method of claim 2, wherein the composite response has at least about 70% reduction in unintended and/or non-compliant responses in comparison to a second composite response generated by a second generative model configured to generate a complete response without accessing the fragment repository.

4. The computer implemented method of claim 1, wherein each text fragment included in the set is exclusively selected from the fragment repository.

5. The computer implemented method of claim 1, wherein the iteratively selecting the set is implemented until a termination condition is met, the termination condition includes at least one of: selection of a stop fragment, reaching a predefined maximum number of text fragments in the set, and reaching a predefined total maximum length of the text fragments in the set.

6. The computer implemented method of claim 1, wherein the input message includes at least one of: a user message or conversation history.

7. The computer implemented method of claim 1, wherein the generative model is implemented as natural language processing (NLP) model.

8. The computer implemented method of claim 7, wherein the NLP model is implemented as a large language model (LLM) or a classifier.

9. The computer implemented method of claim 1, wherein significantly reducing unintended and/or non-compliant responses comprises significantly reducing at least one of: hallucinations, incorrect content, unverifiable content, incoherent content, unintended content, and untimely content.

10. The computer implemented method of claim 1, wherein the fragment repository includes at least one of: individual words, phrases, complete sentences, partial paragraphs, complete paragraphs, partial text item including a first set of a plurality of paragraphs, complete text item including a second set of a plurality of paragraphs.

11. The computer implemented method of claim 1, wherein the generative model includes a trained fragment predictor configured to select fragments exclusively from the fragment repository in view of the input message.

12. The computer implemented method of claim 1, wherein the generative model is trained on a training dataset that includes text external to the fragment repository,
wherein the generative model is in communication with a generation engine configured to perform the iterative selection of the set of fragments,
wherein the input message comprises a first input message; and
further comprising generating a second input message from the first input message, the second input message instructing the generative model to generate the composite response by implementing the assembling as a response to the first input message without including additional text external to the fragment repository.

13. The computer implemented method of claim 1, wherein the fragment repository includes at least one of: new line marker, at least one punctuation mark, and at least one formatting element.

14. The computer implemented method of claim 1, further comprising providing a second user interface for presentation on a display configured for personalizing the fragments included in the fragment repository.

15. The computer implemented method of claim 1, wherein the fragment repository excludes text fragments smaller than the complete word.

16. The computer implemented method of claim 1, wherein at least one fragment of the plurality of predefined text fragments stored by the fragment repository further includes parameterized variable placeholders, and further comprising:
dynamically resolving parameterized variable placeholders in the set of text fragments from contextual data sources.

17. The computer implemented method of claim 16, further comprising:
in response to a failure of dynamically resolving at least one parameterized variable placeholder of at least one candidate text fragment using the contextual data sources, excluding the at least one candidate text fragment from being selected for including in the set of text fragments which are assembled into the composite response.

18. The computer implemented method of claim 1, wherein at least one fragment in the fragment repository is stored in association with contextual cues, and further comprising:
obtaining active contextual cues associated with the input message;
dynamically filtering the plurality of predefined text fragments of the fragment repository based on active contextual cues to generate a filtered set,
wherein the iteratively selecting is performed from the filtered set.

19. A system for controlling a response by a generative model, comprising:
at least one processor executing a code for:
receiving an input message;
maintaining a fragment repository comprising a plurality of predefined text fragments, wherein each text fragment includes at least a complete word;
iteratively selecting, by the generative model, a set of text fragments from the fragment repository based on the input message,
assembling, by the generative model, the set of selected text fragments into a composite response; and
providing the composite response for presentation within a user interface on a display of a client terminal.

20. A non-transitory medium storing program instructions for controlling a response by a generative model, which when executed by at least one processor, cause the at least one processor to:
receive an input message;
maintain a fragment repository comprising a plurality of predefined text fragments, wherein each text fragment includes at least a complete word;
iteratively select, by the generative model, a set of text fragments from the fragment repository based on the input message,
assemble, by the generative model, the set of selected text fragments into a composite response; and
provide the composite response for presentation within a user interface on a display of a client terminal.
